(19) United States
(12) Patent Application Publication
(10) Pub. No.: US 2017/0180822 A1
(43) Pub. Date: Jun. 22, 2017

(54) Real-Time Watermarking of Video Content

(71) Applicant: MediaSilo, Inc., Boston, MA (US)

(72) Inventors: Kai Christian Pradel, Winchester, MA (US); Alex J. Nauda, Melrose, MA (US); Michael Delano, North Hampton, NH (US)

(21) Appl. No.: 15/381,616

(22) Filed: Dec. 16, 2016

Related U.S. Application Data
(60) Provisional application No. 62/269,848, filed on Dec. 18, 2015.

(51) Int. Cl. H04N 21/8358; H04N 21/472; H04N 21/835; H04N 21/254; H04N 21/438

(52) U.S. Cl. CPC H04N 21/8358; H04N 21/2541; H04N 21/438; H04N 21/835; H04N 21/47202; H04N 2201/3233

(57) ABSTRACT

Currently, there is no single turnkey solution for protecting video content online. Instead, the industry norm is to rely on a combination of techniques that aim to restrict access of video streams to only the audience with prior authorization to view the content. Embodiments of the present invention provide real-time methods and systems for watermarking video content by determining personal attribute information of a recipient of the subject video content and, in connection with streaming the subject video content to the recipient, executing a plurality of massively parallel servers to generate a watermark from the personal attribute information and embed the watermark into the subject video content in real-time during streaming of the video content by causing burn-in of the generated watermark into a layout of the subject video content and/or embedding the watermark as a code in the subject video content.

### RELATED APPLICATION

This application claims the benefit of U.S. Provisional Application No. 62/269,848, filed on Dec. 18, 2015. The entire teachings of the above application are incorporated herein by reference.

### BACKGROUND

As online video content increases in popularity, online video content creators are concerned about protecting their investment. Studios, for example, fear that content leaks revealing key plot points could lead to box office losses. Commercial content producers and distributors fear that illegal sharing of streamed video content could result in lower subscription rates.

### SUMMARY OF THE INVENTION

At the heart of the problem is the fact that streaming video over the Internet is inherently unsecure. Files can be intercepted using readily available software or files can be captured by another device such as a smartphone during video play back. Multiple content protection strategies exist but are either ineffective, become effective after a leak has occurred, or sacrifice user experience. Visual watermarking techniques have proven effective but are rarely used due to the time and cost related to applying them at a large scale.

Currently, no single turnkey solution exists for protecting video content online. Instead, the industry norm is to rely on a combination of techniques that aim to restrict access to video streams to only the audience with prior authorization to view the content.

Digital Rights Management

Digital Rights Management (DRM) software typically relies on proprietary player technology in the form of browser plugins or other player software. This approach is inconvenient for the viewer because the DRM software has to be installed and opened before it can be used. Further, the use of DRM in every-day situations is limited. Mobile implementations of DRM software are scarce, cumbersome to use, and expensive. Often, mobile access is completely removed in DRM situations because phone vendors implement video playback differently than browser or OS vendors. DRM is also common in situations where specific hardware is installed such as a set top box.

Geographical Restriction

In another approach, video playback is restricted by geographical region. Geographical restriction determines if the video can be played back based on looking up the region corresponding to the client IP address. However, for this approach to be effective, it must be combined with other content protection strategies.

URL Tokenization and Signatures

Another approach uses URL tokenization and signatures. With this approach, each request to a video is “signed” with an electronic signature that is set to expire shortly after the file is requested. The signature is decoded on the server side to assure that the client is permitted to access content. Once expired, the client is refused access to a file. This approach relies on authentication and is most effective when combined with other content protection strategies.

Forensic Watermarking

In another approach, forensic watermarking embeds a code in a video file that is invisible to the human eye by splitting a frame into small squares that are individually modified. The code is generated on-demand and needs to be stored. Video files have to be de-coded to retrieve the code that then has to be matched to a database of qualifying codes. Forensic watermarking has its roots in the film industry. Theater operators receive watermarked content so that studios can detect which theater leaked footage. Theater operators are required to monitor illegal “taping” of films on release weekends.

A drawback of this approach is that viewers of watermarked content do not know that the content is watermarked and it is therefore, not an effective deterrent. Moreover, with this approach, media content can be copied well before the copying is ever detected. Given its history, this form of watermarking has traditionally been used for content distribution in asynchronous workflows (e.g., where there is no need to provide real-time access to watermarked content).

Encryption

Another approach is encryption of video content. With this approach, content can be transmitted via SSL to prevent man-in-the-middle attacks. However, this has no bearing on what happens to video once it is delivered to the recipient, where it can be downloaded or copied. Encryption should be part of every content delivery strategy but does not prevent theft on its own.

Password Protection

Similar to encryption, wrapping access around authentication should be part of the content protection strategy, but does not prevent theft on its own. Some practices around password protection include single sign-on and multi-form authentication.

Overlay Watermarking

In this approach, overlaid watermarks are added at playback time in a layer above a video stream. For web based playback, common browser markup is used to place text or images above a player stream. This approach gives the illusion of watermarking but savvy users can disable the watermark or obtain a direct link to a stream. This approach also does not work well on mobile devices that prevent overlays in full-screen mode.

Burned-in or “Destructive” Watermarking

Another approach is destructive watermarking. Destructive watermarking is the process of encoding video with a visible watermark. This approach is a common practice today and can be an effective deterrent when it contains user identifiable information. However, the task of destructive watermarking video is time consuming. If many viewers can access a piece of content, destructive watermarking each unique file makes this approach impractical for most applications.

The lack of real-time content protection is an obstacle for content creators to securely share and distribute content. Embodiments of the present invention solve the problems faced by existing content protection approaches by employing real-time methods and systems for watermarking of video streams. The features of the present invention enable content creators to securely share and distribute content throughout the media supply chain. The present invention combines many best security practices with on-demand watermarking, especially destructive and/or forensic watermarking, to deliver a secure file delivery experience.

In an example embodiment of the present invention, a computer-implemented method implements real-time watermarking of video content. The example method determines personal attribute information of a recipient of the subject video content and, in connection with streaming the subject video content to the recipient, executes a plurality of massively parallel servers to generate a watermark from the personal attribute information and embed the watermark into the subject video content in real-time during streaming of the video content by causing burn-in of the generated watermark into a layout of the subject video content and/or embedding the watermark as a code in the subject video content.

In another example embodiment of the present invention, a computer-based system watermarks video content in real-time. The example system includes a plurality of massively parallel servers configured to generate a watermark and embed the watermark into the subject video content in real-time during streaming of the video content by causing burn-in of the generated watermark into a layout of the subject video content and/or embedding the watermark as a code in the subject video content. The system also includes one or more processors configured to determine personal attribute information of a recipient of the subject video content and, in connection with streaming the subject video content to the recipient, execute the plurality of massively parallel servers to generate the watermark from the personal attribute information.

In another example embodiment of the present invention, a machine readable storage medium has stored thereon a computer program for real-time watermarking of a subject video content. The computer program includes a routine of set instructions for causing the machine to determine personal attribute information of a recipient of the subject video content and, in connection with streaming the subject video content to the recipient, execute a plurality of massively parallel servers to generate a watermark from the personal attribute information and embed the watermark into the subject video content in real-time during streaming of the video content by causing burn-in of the generated watermark into a layout of the subject video content and/or embedding the watermark as a code in the subject video content.

In many embodiments, the methods or systems can divide the subject video content into segments and cause the plurality of massively parallel servers to embed the watermark into the segments of the subject video content. In some embodiments, the methods and systems may access a watermark template that is stored in memory and that enables generation of the watermark according to pre-stored settings and the personal attribute information, where the watermark template is used to generate different watermarks for different recipients of the subject video content as a function of at least the personal attribute information. In such embodiments, generating the watermark from the personal attribute information includes employing the watermark template to generate the watermark according to the pre-stored settings and the personal attribute information. The pre-stored settings may specify a start time for initiating the embedding of the configured watermark into the subject video content. The watermark can be a personalized watermark according to the personal attribute information. The personal attribute information can includes identifying information about the recipient of the subject video content, such as an IP address associated with the recipient, a name of the recipient, a time of day, or an email address of the recipient. Some embodiments may embed a general watermark into a pre-roll of the subject video content before streaming and embed the personalized watermark into the subject video content during streaming. In such embodiments, streaming the subject video content can include transitioning from the pre-roll watermarked content to the personalized watermarked content after the personalized watermark is embedded into the subject video content.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a block diagram illustrating a computer system for real-time watermarking of a subject video content, according to an example embodiment of the present invention with generation of a pre-roll watermark.

FIG. 1B is a block diagram illustrating a computer system for real-time watermarking of a subject video content, according to an example embodiment of the present invention without generation of a pre-roll watermark.

FIG. 1C is a flow diagram illustrating a computer-implemented method for real-time watermarking of a subject video content, according to an example embodiment of the present invention.

FIG. 2 is a diagram illustrating a watermarking template settings editor according to an embodiment of the present invention.

FIG. 3 is a screenshot illustrating a watermarking template settings editor according to an embodiment of the present invention.

FIG. 4 is a diagram illustrating a computer network or similar digital processing environment in which embodiments of the present invention may be implemented.

FIG. 5 is a diagram of the internal structure of a computer in a computer system.

### DETAILED DESCRIPTION OF THE INVENTION

A description of example embodiments of the invention follows.

Embodiments of the invention use a unique process to determine and apply a watermark and provide watermarked files ready for playback in real-time.

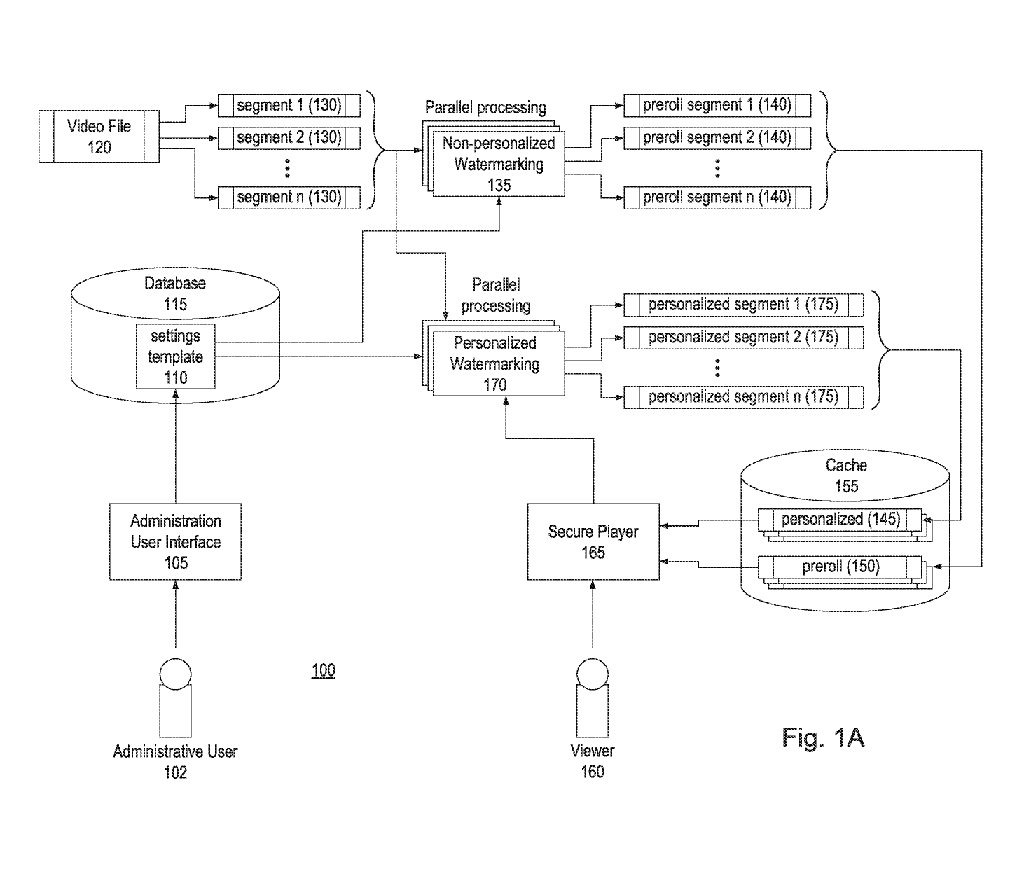

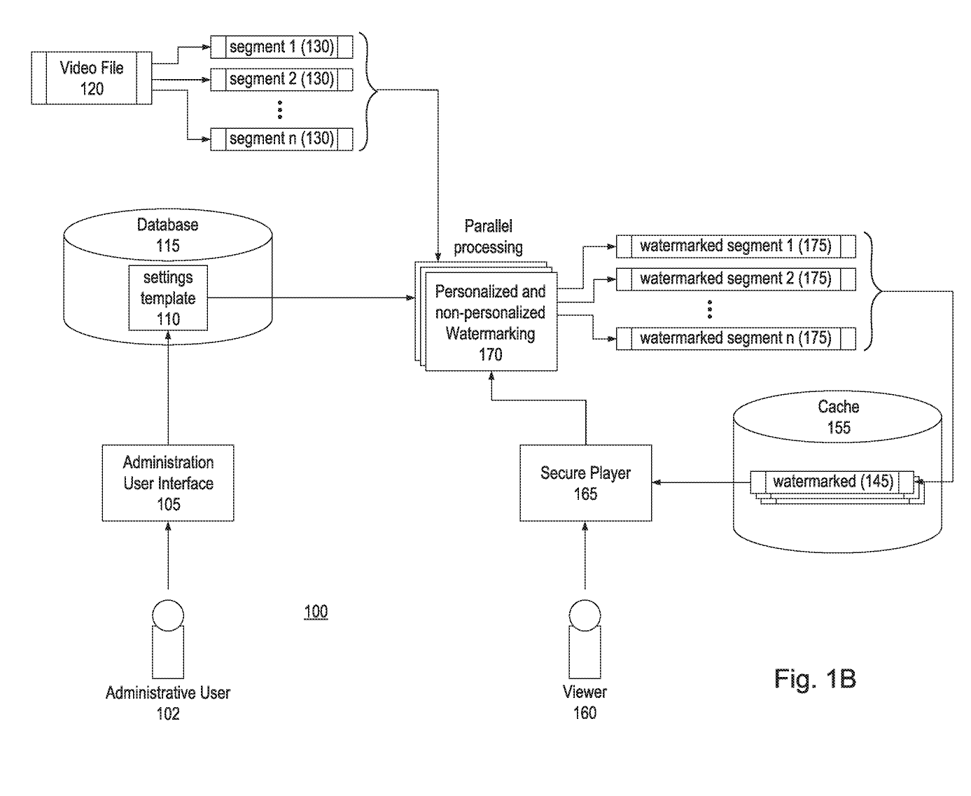

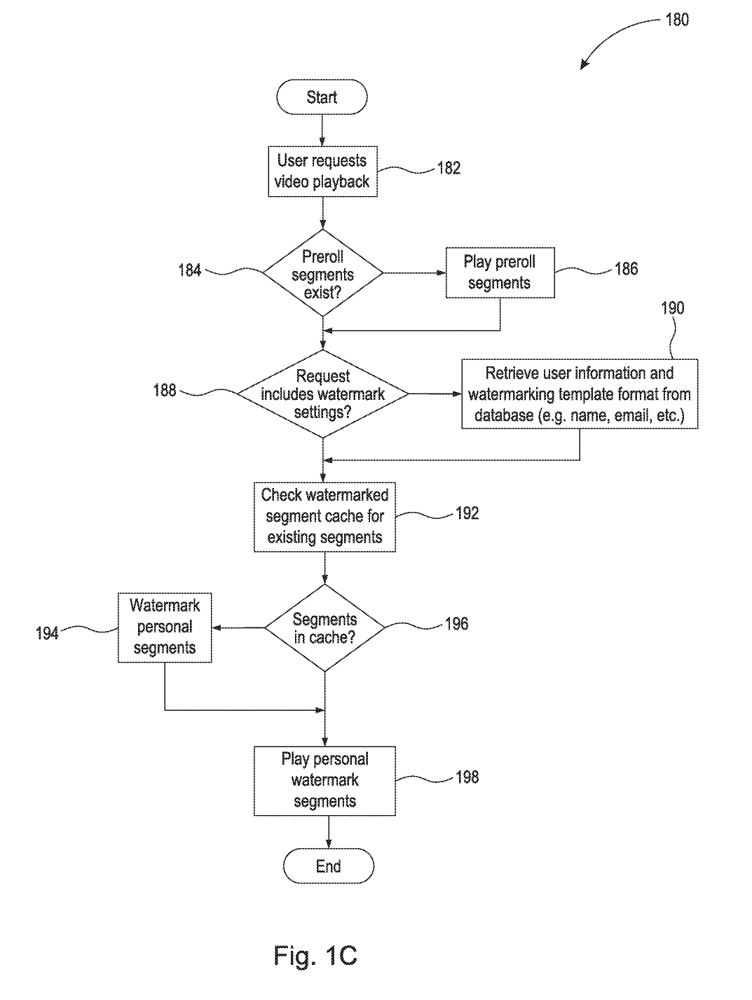

FIG. 1A is a block diagram illustrating an embodiment 100 of the present invention. An administrative user 102 may configure a watermark settings template 110 for an asset or group of assets, in an application using a user interface 105. The settings template 110 may include text and image components and a desired layout of those components on the watermarked asset. The text components may be non-personalized (e.g., “Property of Example Corp”) or personalized (e.g., name or email address of the person viewing the asset). The settings template can be saved in a database 115 stored in computer memory.

Video asset files 120 can be prepared for future watermarking by segmenting the video asset files 120 into a number of initial segments 130. For example, using a 4-second segment, a typical 22-minute television episode would be segmented into 330 files, and a typical 45-minute television episode would be segmented into 675 files. Other segment lengths may also be used. Personal information is removed from the settings template 110, if a template is used, and the resulting non-personalized template is applied as input to a non-personalized watermarking process 135. One or more initial segment(s) 130 of the video asset 120 are watermarked in the non-personalized watermarking process 135 using the non-personalized settings and resulting in a set of pre-roll segment(s) 140. The pre-roll segments 140 are stored in a cache 155 and the video asset is ready to instantly start playing in response to a playback request.

A viewer 160 requests playback of a watermarked asset via a secure player 165. The viewer 160 can be authenticated to the secure player 165 by a login or a unique identifier, so that the secure player 165 can identify the individual or group viewing the asset. The pre-roll (non-personalized) segment(s) 150 from cache 155 may be delivered to the viewer 160 immediately and playback of the video asset may start immediately.

The secure player 165 then requests personalized watermarking of the video asset 120. The request includes information identifying the viewer 160. In response to the request, the personalized watermarking procedure/routine 170 applies the settings template 110, if a template is used, with personal information resolved to the identity of the viewer 160. If the personalized segment(s) 145 are not already present in the cache 155, the personalized watermarking process 170, executing in parallel to the playback of the pre-roll, watermarks the asset segment(s) 130 using the personalized settings in the settings template 110 and forms personalized segments 175. The personalized watermarking process 170 stores the personalized segment(s) 175 in cache 155 (at 145) and completes the watermarking of personalized segments 175, 145 before the video playback reaches the end of the last segment of pre-roll 150 in cache 155.

Personalized watermarking 170 is applied at the video stream level by burning-in (destructive marking) user identifiable information into a video stream, on demand. In destructive watermarking, the video segment is decoded to baseband video data, an overlay of text and/or image(s) is applied, and video data is re-encoded to produce the output segment. In forensic watermarking, a payload is applied to the segment, using techniques specific to the forensic technology, to produce the output segment. Every video stream post-watermarking is therefore unique and can be traced back to the person who was authorized, thereby identifying the source of any leaked content. Watermarks can be based on dynamic variables such as a user's name, IP address, time of day, region, or other identification. In response to a media request, the viewer 160 sees a custom video stream (or download) that contains dynamically or statically merged overlays. Every stream is unique to each viewer without the need of a human to anticipate which user wants to watch which clip.

The personalized segment(s) 145 are stored in cache 155. The personalized segment(s) 145 are delivered to the viewer 160 via the secure player 165, in time to preserve continuous playback of the video. The secure player 165 transitions from the non-personalized pre-roll segments 150 to the personalized segments 145, both of the cache 155, and the remainder of the video is played back containing watermarking with personal information of the viewer 160. The transition from pre-roll to personalized segments may be handled by the player (by playing a new video track containing the personalized segments) or by the server (in cases where this is feasible by using a segmented playlist manifest file, as in HTTP Live Streaming or MPEG-DASH).

Users, such as administrators and project managers, can define a watermark template 110 that contains static text fields, image data, and variables that merge dynamic data into a stream when it is requested. For example, the project manager may define the template 110 by setting static text (e.g., “Property of BBC”) or by setting variables, such as “IP Address”, “Current Time”, “User Name”, “User Email Address”, or “User ID”. The template 110 may have a field for setting start time for initiating the embedding of a watermark. Once the template 110 is set, the template can be applied to all media (video assets) within a project folder.

Generation of pre-roll segments is optional. In some embodiments, pre-roll segments are not generated. FIG. 1B is an embodiment of the present invention without the generation of pre-roll segments. An administrative user 102 can configure a watermark settings template 110 for an asset or group of assets, in an application using a user interface 105. The settings template 110 may include text and image components and the desired layout of those components on the watermarked asset. The text components may be non-personalized or personalized. The settings template can be saved in a database 115 stored in computer memory.

Video asset files 120 can be prepared for future watermarking by segmenting the video asset files 120 into a number of initial segments 130. For example, using a 4-second segment, a typical 22-minute television episode would be segmented into 330 files, and a typical 45-minute television episode would be segmented into 675 files. Other segment lengths may also be used.

A viewer 160 requests playback of the video asset via the secure player 165. The viewer 160 is authenticated to the secure player 165 by a login or a unique identifier, so that the secure player 165 can identify the individual or group viewing the video asset. The secure player 165 requests watermarking of the video asset 120. The request includes information identifying the viewer 160.

In response to the request, the watermarking procedure/routine 170 applies the settings template 110, if a template is used, with personal information resolved to the identity of the viewer 160. If the watermarked segment(s) 145 are not already present in the cache 155, the watermarking process 170 watermarks the asset segment(s) 130 using the personalized settings in the settings template 110, if a template is used, and forms personalized segments 175.

Personal information may be removed from the settings template 110 and the resulting non-personalized template may also be applied as an input to the watermarking process 170. One or more initial segment(s) 130 of the video asset 120 may be watermarked in the watermarking process 170 using the non-personalized settings.

The watermarking process 170 stores the watermarked segment(s) 175 in cache 155 (at 145) and completes the watermarking of segments 175. The watermarked segment(s) 145 are delivered to the viewer 160 via the secure player 165.

FIG. 1C is a flow diagram illustrating a computer-implemented method 180 for real-time watermarking of a subject video content, according to an example embodiment of the present invention. According to the example method 180, a user requests (182) video playback, and if pre-roll segments exist (184) for the video playback, then the pre-roll segments are played (186). If the request for video playback includes watermark settings (188), then user information and a watermarking template format is retrieved (190) from a database. The user information and a watermarking template format may include information such as the user's name and email, for example. A watermarked segment cache is checked (192) for already existing watermarked segments. If at least some watermarked segments already exist (196), then those segments are played (198); however, if there are segments that are not already present in the cache, the method 180, executing in parallel to the portion of the video being played, watermarks (194) the video segment using the user information and watermarking template to form personalized watermarked segments for playback.

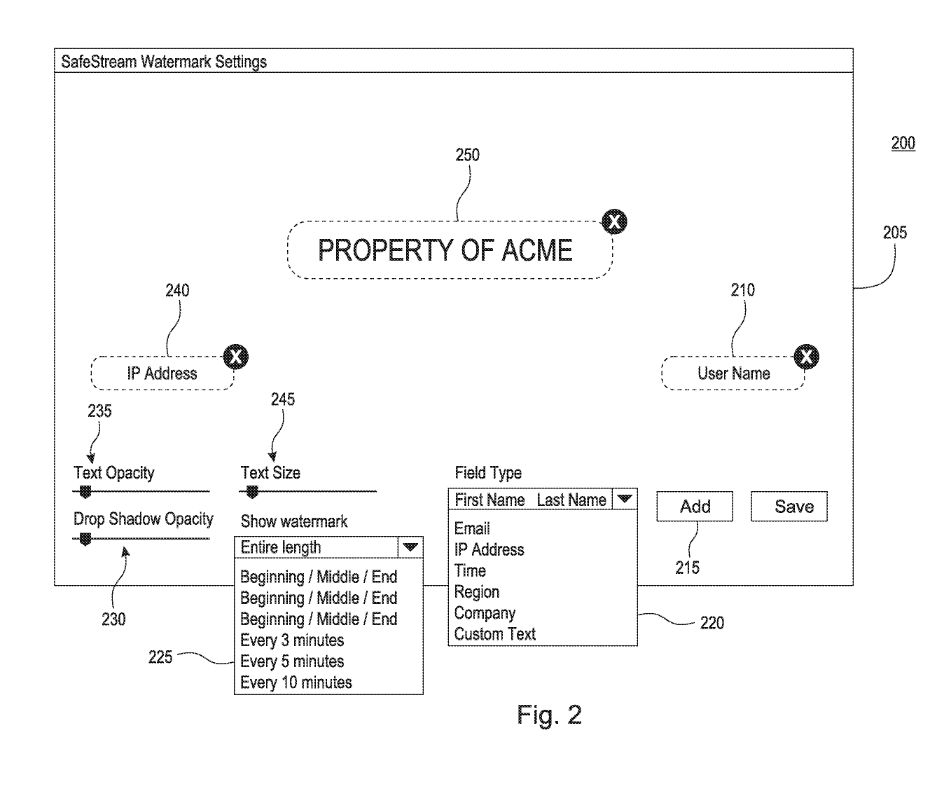

FIG. 2 is a schematic diagram illustrating a watermark template settings editor 200 according to an example embodiment of the present invention. A user may define a watermark template using the settings available in the editor 200. Settings may include text and image components 210, 240, 250 and the layout/position 205 of these components 210, 240, 250 in the watermarked asset. The text components 250 may be non-personalized (e.g., “Property of ACME”) or personalized (e.g., “IP Address” 240 or “user name” 210). Text Opacity 235, Text Size 245 and Drop Shadow Opacity 230 further define the presentation of the text components 210, 240, 250 in the watermarked asset. A Show watermark 225 option specifies the spatial or temporal point for insertion of the watermark template within the asset. Field Type 220 selects the type of image or text component, and subsequently clicking on Add button 215 creates a new text component box (e.g., 210, 240, 250) that can be positioned on the screen. The user may click and drag the text components 210, 240, 250 around the screen to fine tune their positions and the overall layout.

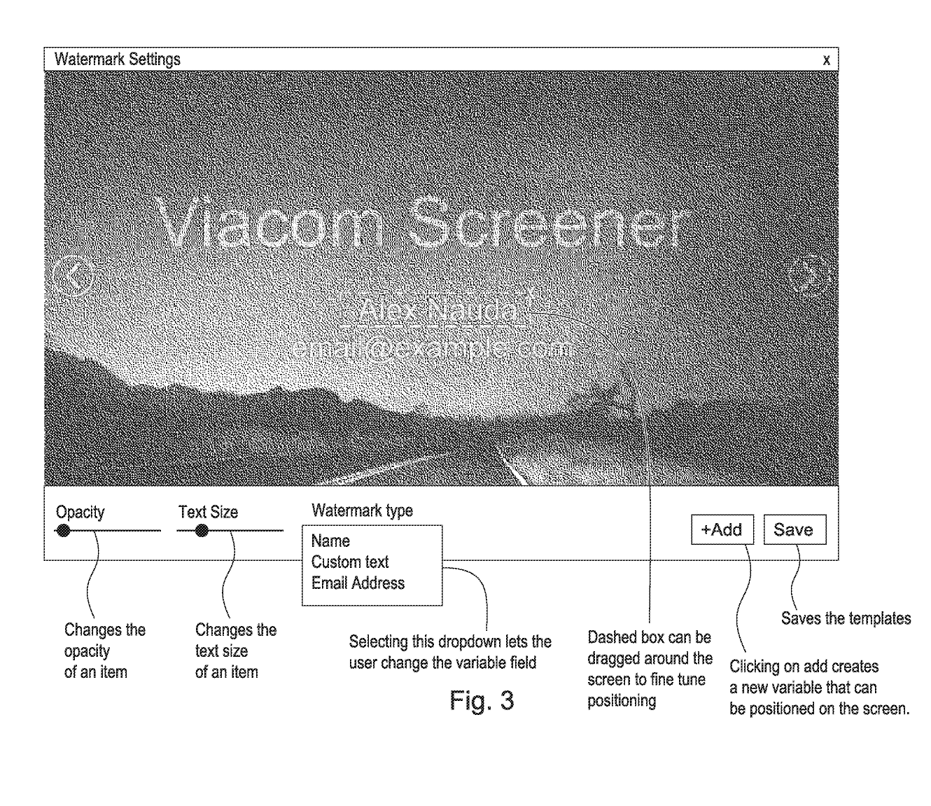

FIG. 3 is a screenshot 300 of a watermark template settings editor according to an embodiment of the present invention. The screenshot 300 is illustrative of the user-interactive text, image fields, and other settings of the graphical user interface detailed in FIG. 2 above.

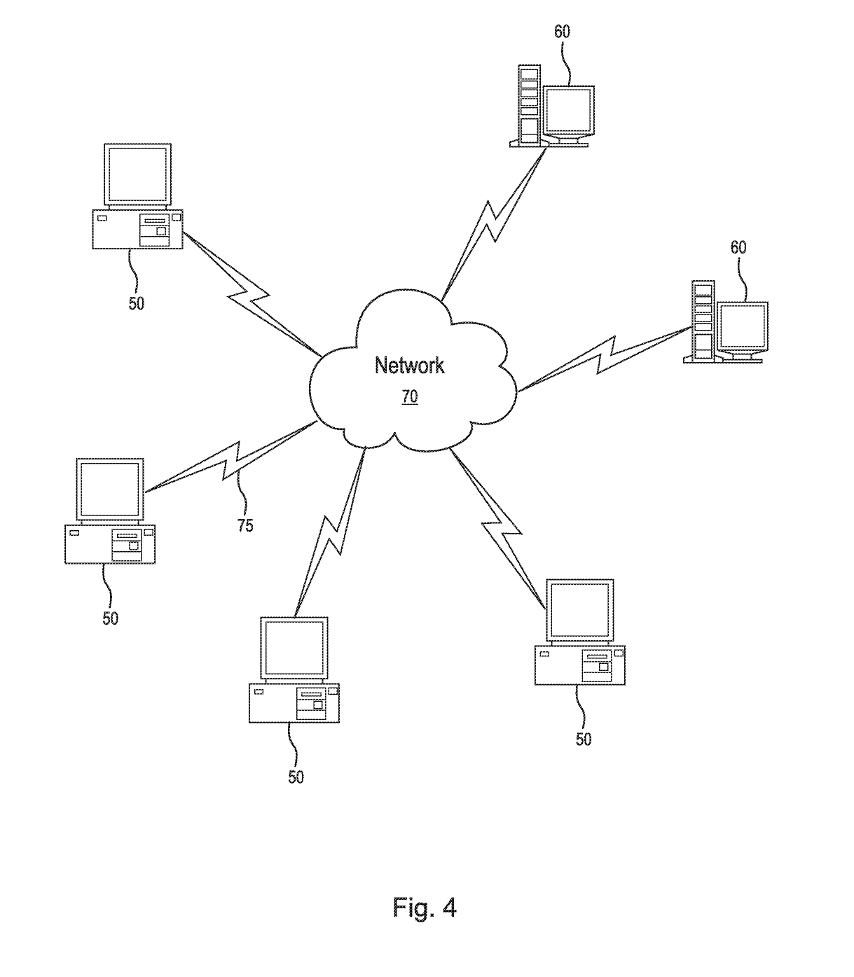

FIG. 4 illustrates a computer network or similar digital processing environment in which embodiments of the present invention may be implemented. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60, via communication links 75 (e.g., wired or wireless network connections). The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

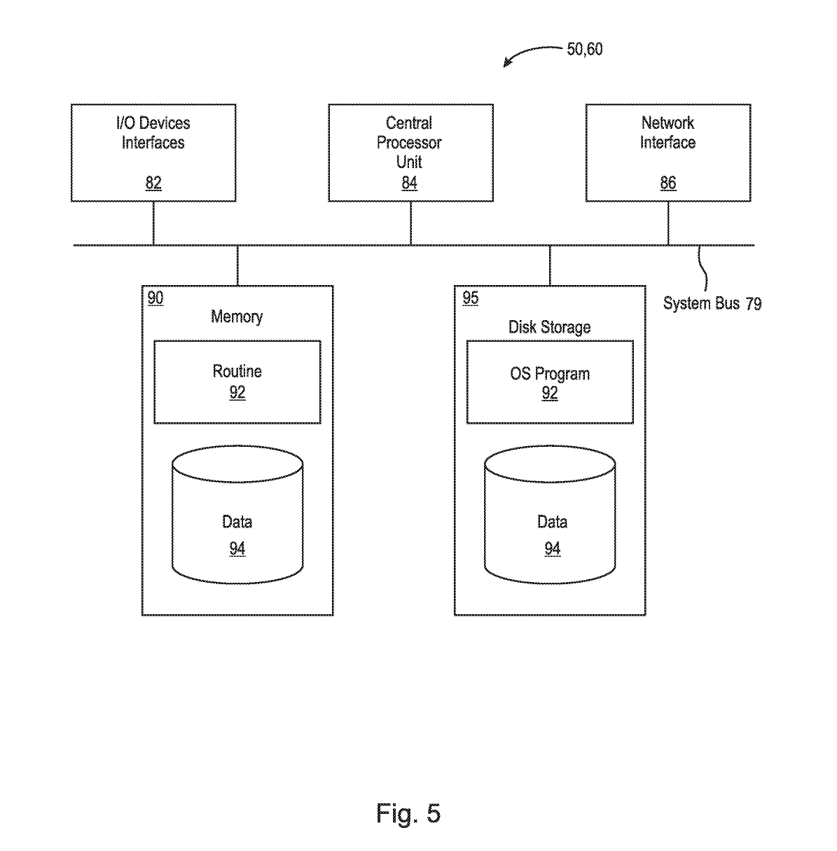

FIG. 5 is a diagram of the internal structure of a computer (e.g., client processor/device 50 or server computers 60) in the computer system of FIG. 4. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 4). Memory 90 provides volatile storage for computer software instructions 92 and data 94 used to implement an embodiment of the present invention (e.g., watermarking system 100, code and template settings editor user interface 200, 300, and supporting code detailed above). Disk storage 95 provides non-volatile storage for computer software instructions 92 and data 94 used to implement an embodiment of the present invention. Central processor unit 84 is also attached to system bus 79 and provides for the execution of computer instructions. In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A computer-implemented method for real-time watermarking of a subject video content, the method comprising:
determining personal attribute information of a recipient of the subject video content; and
in connection with streaming the subject video content to the recipient, executing a plurality of massively parallel servers to generate a watermark from the personal attribute information and embed the watermark into the subject video content in real-time during streaming of the video content by (i) causing burn-in of the generated watermark into a layout of the subject video content or (ii) embedding the watermark as a code in the subject video content.

2. A method as in claim 1 wherein embedding the watermark into the subject video content includes:
dividing the subject video content into segments; and
executing the plurality of massively parallel servers to embed the watermark into the segments of the subject video content.

3. A method as in claim 1 further comprising:
accessing a watermark template that is stored in memory and enables generation of the watermark according to pre-stored settings and the personal attribute information, the watermark template used to generate different watermarks for different recipients of the subject video content as a function of at least the personal attribute information; and
wherein generating the watermark from the personal attribute information includes employing the watermark template to generate the watermark according to the pre-stored settings and the personal attribute information.

4. A method as in claim 3 wherein the pre-stored settings specify a start time for initiating the embedding of the configured watermark into the subject video content.

5. A method as in claim 1 wherein the watermark is a personalized watermark according to the personal attribute information.

6. A method as in claim 5 wherein the personal attribute information includes identifying information about the recipient of the subject video content.

7. A method as in claim 6 wherein the identifying information about the recipient includes an IP address associated with the recipient, a name of the recipient, a time of day, or an email address of the recipient.

8. A method as in claim 5 further comprising:
embedding a general watermark into a pre-roll of the subject video content before streaming; and
embedding the personalized watermark into the subject video content during streaming.

9. A method as in claim 8 wherein streaming the subject video content includes transitioning from the pre-roll watermarked content to the personalized watermarked content after the personalized watermark is embedded into the subject video content.

10. A computer system for real-time watermarking of a subject video content, the system comprising:
a plurality of massively parallel servers configured to generate a watermark and embed the watermark into the subject video content in real-time during streaming of the video content by (i) causing burn-in of the generated watermark into a layout of the subject video content or (ii) embedding the watermark as a code in the subject video content; and
one or more processors configured to determine personal attribute information of a recipient of the subject video content and, in connection with streaming the subject video content to the recipient, execute the plurality of massively parallel servers to generate the watermark from the personal attribute information.

11. A system as in claim 10 wherein the one or more processors is configured to divide the subject video content into segments and cause the plurality of massively parallel servers to embed the watermark into the segments of the subject video content.

12. A system as in claim 10 further comprising:
a watermark template that is stored in memory and enables generation of the watermark according to pre-stored settings and the personal attribute information, the watermark template used to generate different watermarks for different recipients of the subject video content as a function of at least the personal attribute information; and
wherein the one or more processors and the plurality of massively parallel servers are configured to employ the watermark template to generate the watermark according to the pre-stored settings and the personal attribute information.

13. A system as in claim 12 wherein the pre-stored settings specify a start time for initiating the embedding of the configured watermark into the subject video content.

14. A system as in claim 10 wherein the watermark is a personalized watermark according to the personal attribute information.

15. A system as in claim 10 wherein the personal attribute information includes identifying information about the recipient of the subject video content.

16. A system as in claim 15 wherein the identifying information about the recipient includes an IP address associated with the recipient, a name of the recipient, a time of day, or an email address of the recipient.

17. A system as in claim 14 wherein the subject video content includes a general watermark in a pre-roll portion of the subject video content.

18. A system as in claim 17 wherein the one or more is configures to transition from the pre-roll watermarked content to the personalized watermarked content after the personalized watermark is embedded into the subject video content.

19. A machine readable storage medium having stored thereon a computer program for real-time watermarking of a subject video content, the computer program comprising a routine of set instructions for causing the machine to:
determine personal attribute information of a recipient of the subject video content; and
in connection with streaming the subject video content to the recipient, execute a plurality of massively parallel servers to generate a watermark from the personal attribute information and embed the watermark into the subject video content in real-time during streaming of the video content by (i) causing burn-in of the generated watermark into a layout of the subject video content or (ii) embedding the watermark as a code in the subject video content.

20. A machine readable storage medium as in claim 19 wherein the computer program further comprises instructions for causing the machine to:
divide the subject video content into segments; and
execute the plurality of massively parallel servers to embed the watermark into the segments of the subject video content.
